(19) United States
(12) Patent Application Publication
(10) Pub. No.: US 2014/0337361 A1
(43) Pub. Date: Nov. 13, 2014

(54) USER-SPECIFIC FEED GENERATION SYSTEM

(71) Applicant: PIAZZA TECHNOLOGIES, INC., Palo Alto, CA (US)

(72) Inventor: Renars GAILIS, Palo Alto, CA (US)

(73) Assignee: PIAZZA Technologies, Inc., Palo Alto, CA (US)

(21) Appl. No.: 13/891,072

(22) Filed: May 9, 2013

(51) Int. Cl. G06F 17/30

(52) U.S. Cl. CPC G06F 17/30699
USPC 707/752; 707/736

(57) ABSTRACT

Techniques are disclosed for generating a web-based user content feed given a set of sort and filter criteria. Upon receiving such criteria from a client web browser application, a feed server merges a first feed object and a second feed object having subsets of metadata deriving from a feed item table in the database. The feed server performs the sort, filter, and search operations on the sortable list and retrieves the full metadata from the database. The feed server returns the result to the client web browser application, which displays the content feed to a user.

### BACKGROUND

1. Field

Embodiments disclosed herein generally relate to techniques for creating content feeds displayed on a web browser. More specifically, techniques disclosed herein provide an approach for sorting, filtering, and searching user content feeds based on given criteria.

2. Description of the Related Art

A number of web services use dynamic content feeds to present information to a user through a web browser application. Content feeds may contain information for the user in the form of message posts, notifications, images, and the like. Typically, users do not need to refresh a web page to retrieve new content. Rather, as new content becomes available (e.g., when another user creates or responds a post), the browser receives and displays new feed content in real time. Additionally, some services allow a user to sort, filter, and search through content. As more information becomes available to a user, the user may specify, for example, how many posts the feed should display, as well as criteria for selecting which posts to display. In some cases, content feeds are user-specific. For example, the number of updates a user has seen for a certain post may differ from the number seen by another user. Further, the list of items may also differ from user to user, because one user may remove a certain post from the content feed, whereas another may retain the post.

A web service may store a feed in a database as one object containing data and metadata for every item in the feed. When a user requests to sort or filter the feed, the server retrieves the feed object, performs the necessary database operations, and returns the result to the browser application. However, as a web service grows in terms of users, or even user activity, the number of feed items in the database grows larger, resulting in a greater feed object file size. Thus, accessing the entire feed each time a user requests to sort and filter a feed or even displaying a smaller number of feed items to the user becomes computationally expensive and impractical. Moreover, as the web service grows in user activity, changes to the feed state become more frequent (e.g., larger amount of posts and content updates), resulting in more available content that a user may want to sort. This underscores the importance of more efficiently generating feeds for users of a web service.

### SUMMARY

One embodiment presented herein includes a method for generating a content feed. This method may generally include loading a first feed object referencing a first set of feed items. The first feed object includes feed metadata for each feed item in the set of feed items. This method also includes loading one of a plurality of second feed objects. The second feed object references one or more of the feed items in the first set. The second feed object includes user metadata for each feed item referenced by the second feed object for one of a plurality of users. For each feed item referenced by the second feed object, the user metadata is merged with the feed metadata for the corresponding feed item in the first feed object to create a merged feed object. This method also includes identifying a set of feed items referenced in the merged feed object and retrieving the feed items referenced in the merged feed object.

Other embodiments include, without limitation, a computer-readable medium that includes instructions that enable a processing unit to implement one or more aspects of the disclosed methods as well as a system having a processor, memory, and application programs configured to implement one or more aspects of the disclosed methods.

### BRIEF DESCRIPTION OF THE DRAWINGS

Note that the appended drawings illustrate only typical embodiments of this invention and are therefore not to be considered limiting of its scope, for the invention may admit to other equally effective embodiments.

FIG. 1 illustrates an example browser application interface where feed content may be presented to a user, according to one embodiment.

FIG. 2 illustrates an example computing environment, according to one embodiment.

FIG. 3 illustrates an example feed item and feed objects, according to one embodiment.

FIG. 4 illustrates an example specific-use case feed generation scenario given a set of feed items, according to one embodiment.

FIG. 5 illustrates a method for generating a user-specific content feed based on given criteria, according to one embodiment.

FIG. 6 illustrates an example feed server computing system configured to generate a user-specific content feed, according to one embodiment.

### DETAILED DESCRIPTION

Embodiments presented herein provide techniques for efficiently generating a content feed, given user-specific criteria. More specifically, a feed server stores feed items as separate database objects in a feed item table. Further, the feed server stores two subsets of feed item metadata across two feed objects, one feed object being user-specific. When a browser application requests a feed, the feed server merges the feed objects into a sortable list. The server performs sorting, filtering, and search operations on the list and accesses the feed item table to retrieve the results. Upon doing so, the feed server returns feed item data to the browser application. Because the entire feed item list with complete metadata is not required for sorting, filtering, and searching, which allows a web service using content feeds to retrieve and provide feed content to a client web browser application.

For example, a web service may use dynamic feeds to present user content targeted to university classes. Such a service could allow users (in this case, students and instructors of a class) to publicly ask questions, answer questions, and post notes related to a particular class. To participate in a class, a user subscribes to a class and accesses a self-contained class page. From the class page, a user may post questions that other users may view. Each question prompts a collective answer to which any user can contribute and an instructor can answer. Users may attach external files to the posts and also add follow-up questions. A user interface presents these questions through a dynamic feed. The feed displays posts to the user, and each post may receive replies soon after being posted. Additionally, the interface may allow users to endorse, edit, and “like” posts in the feed authored by other users, and these actions are reflected on the feed.

In one embodiment, a web service may include a feed server that generates and provides feed content to users of the service. The feed server may be configured with a database storing tables used in feed generation. For instance, a feed server may include a feed item table that stores all feed items as separate database objects (as opposed to one object representing the entire feed). Generally, the feed item table contains data that the feed server accesses in generating a feed for the user. Each feed item includes a unique identifier, data needed to display the feed item on a user interface, and other metadata associated with the feed item. For example, in the university class web service example described above, one type of feed item is a “question” item. Data of a question item may include a subject and the amount of characters in the question body. Metadata of the question item may include who asked the question, how many updates (i.e., follow-up posts to a question) have been made, whether the question had been edited, and the like.

Further, the feed server database may include two additional content feed tables for sorting, filtering, and searching feed items for a user. One of the content feed tables is a user feed table. The user feed table stores objects corresponding to all items for a particular feed. These feed items contain the same identifiers as those in the feed item table. However, feed items in a user feed object contain only a subset of associated metadata. The subset of metadata in each user feed item is specific to a user. For instance, in the university class web service example, user-specific metadata may be how many updates a user has seen for a particular question. Similarly, the other content feed table stores objects corresponding to all items for a particular feed with the same data but only a subset of associated metadata. The associated metadata includes only the information that a feed server uses for a sort, filter, and search operation. In the continuing example, the other content feed table is a class feed table, where the subset of metadata of a class feed object may include information such as the date the post was created and how many “likes” or endorsements the post has received. Of course, other criteria used in sorting, filtering, and search may also be included in the metadata subset.

In one embodiment, when a user requests a feed, using the continuing class web service example, the feed server merges the class feed object with the user feed object to create a user-specific feed item list whose items contain a combination of the metadata subsets from the class feed object and the user feed object. The server sorts, filters, and searches the list based on the given criteria. For example, if a user requests to see the most recently updated posts that remain unread, the feed server accordingly sorts the posts with the most recent timestamps while removing posts that have been flagged as having already been viewed. Once the feed server has sorted, filtered, and searched the list, the server retrieves the complete metadata of the resulting items from the feed item table. Upon doing so, the feed server returns the feed items to the client web browser application, and the browser application displays the feed to the user. That is, rather than loading an entire feed object and performing database queries on entire feed data, this method only uses the metadata necessary for sorting, filtering, and search, which allows a feed server to optimally retrieve selected feed data for the user. This operation requires substantially less memory than if the feed server loaded the full metadata of all feed items when performing the operations.

In the following, reference is made to embodiments of the invention. However, the invention is not limited to specific described embodiments. Instead, any combination of the following features and elements, whether related to different embodiments or not, is contemplated to implement and practice the invention. Furthermore, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples a computer readable storage medium include: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the current context, a computer readable storage medium may be any tangible medium that can contain, or store a program for use by or in connection with an instruction execution system, apparatus or device.

The flowchart and block diagrams in the Figures illustrate the architecture, functionality and operation of possible implementations of systems, methods and computer program products according to various embodiments of the present invention. In this regard, each block in the flowchart or block diagrams may represent a module, segment or portion of code, which comprises one or more executable instructions for implementing the specified logical function(s). In some alternative implementations the functions noted in the block may occur out of the order noted in the figures. For example, two blocks shown in succession may, in fact, be executed substantially concurrently, or the blocks may sometimes be executed in the reverse order, depending upon the functionality involved. Each block of the block diagrams and/or flowchart illustrations, and combinations of blocks in the block diagrams and/or flowchart illustrations can be implemented by special-purpose hardware-based systems that perform the specified functions or acts, or combinations of special purpose hardware and computer instructions.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources. A user can access any of the resources that reside in the cloud at any time, and from anywhere across the Internet.

In the following, reference is made to a collaborative university class web service generating user-specific feeds by merging a “class feed” database object and a “user feed” database object. Such reference is made to demonstrate one framework where the disclosed embodiments may be used. The disclosed techniques may be applicable to other web services that display content to a user through a dynamic feed by merging objects together that contain only subsets of feed item metadata used in feed generation for sorting, filtering, and searching.

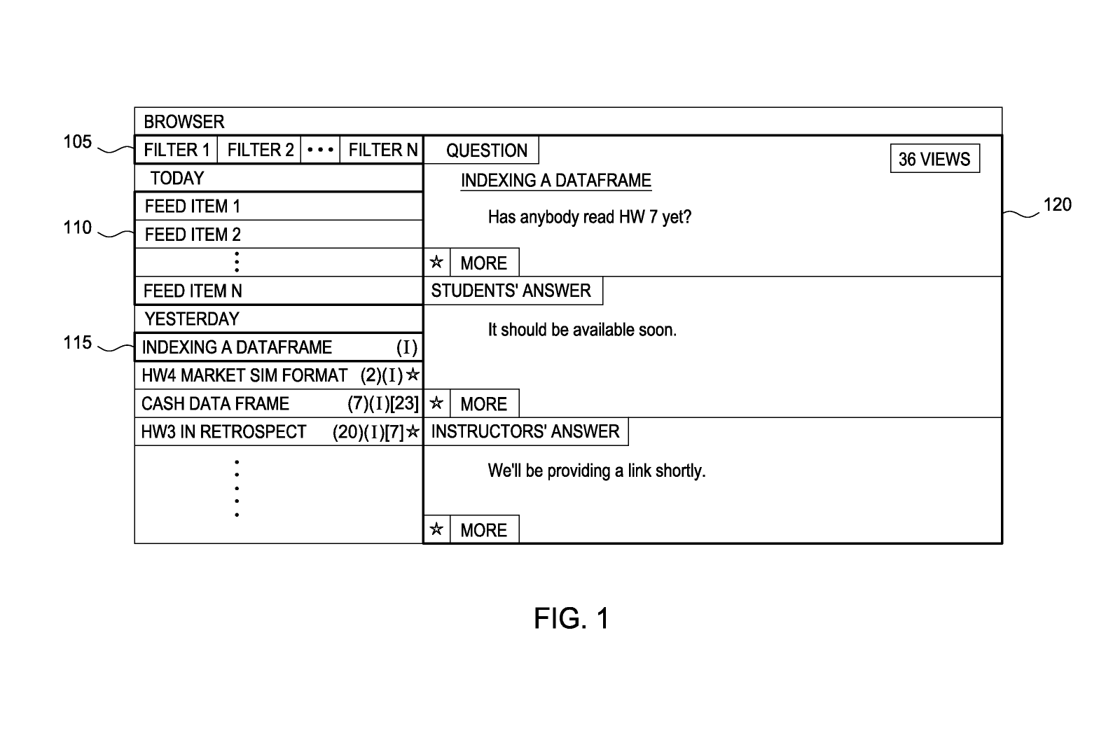

FIG. 1 illustrates an example browser application interface 100 where feed content may be presented to a user, according to one embodiment. As an example, FIG. 1 displays the user interface for an example collaborative web service targeted at university classes. As stated above, the web service allows participants of a particular course to post questions, answers, and notes related to the course. Browser interface 100 shows an example class page presented to a user. A user may browse through posts by clicking on the post subjects located on the left panel of interface 100, represented in FIG. 1 as feed items 110 and 115. When the user clicks on a subject, the post is displayed on the right panel of the screen, represented in FIG. 1 as panel 120. As shown, the post may be represented as a question for the class. Below the question, students and instructors may provide answers. Interface 100 displays the number of views shown on the upper right corner of panel 120.

The left panel of interface 100 represents a feed presented to a user. Feed items 115 show more specific detail of what information the items may convey. For instance, feed items 115 show example post subjects as well as the number of updates each item has received (as shown by the numbers in parentheses), whether an instructor has replied to the post (as shown by the letter “I” in parentheses), how many “likes” each item has received (as shown by the numbers in brackets), and whether a post has been marked as a “favorite” by a user (as shown by the star symbol). To filter the posts shown, the user may choose filters 105 from the upper left corner of interface 100. For example, in the continuing example, a user may filter based on unread posts, recently updated posts, unresolved questions, posts that the user follows, etc. When a user selects one of the filters 105, interface 100 updates the feed to reflect the sorting and filtering operations that have occurred in the backend.

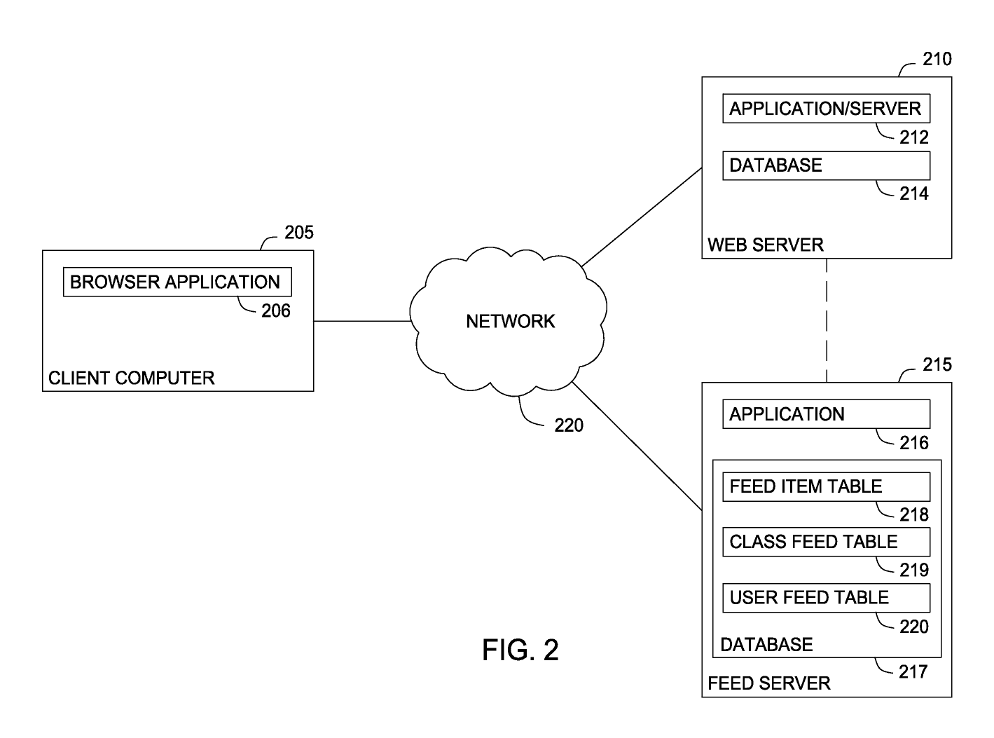

FIG. 2 illustrates an example computing environment 200, according to one embodiment. The computing environment 200 allows a feed server 215 to optimally generate user-specific feeds based on given criteria. As shown, the computing environment includes a web server 210 hosting a computing resource (e.g., application/service 212) and a database 214. Of course, web server 210, application/server 212, and database 214 may also be hosted on separate machines or consist of many separate machines. The web server 210 may be a physical computing system (e.g., a system in a data center) or may be a virtual computing instance executing within a computing cloud. In any event, web server 210 receives HTTP GET requests from a browser application 206. Upon receiving a request, web server 210 may generate a response from the application/data 212 and other data from database 214. Such a response may be formatted as an HTML web page. Thereafter, web server 210 generates output for the browser application 206. Web server 220 is connected to feed server 215. Feed server 215 includes an application 216 and a database 217. Application 216 is a computing resource that generates a feed as well as sorts and filters the feed. Database 217 contains all the database items needed to generate a feed: a feed item table 218, a class feed table 219, and a user feed table 220. Feed item table 218 includes feed items for a particular class. In one embodiment, feed items in the feed table 218 may be separate database objects having unique identifiers and metadata. Class feed table 219 includes all of the feed items for a particular class, retaining the identifiers of the feed items but only including a subset of the original feed item metadata that feed server 215 uses for sorting and filtering operations, such as the date a feed item was created. User feed table 219 contains all of the feed items for a particular class, retaining the identifiers of the feed items but only including a subset of the original metadata related to user-specific attributes, such as how many updates to a post have been made since the user last viewed the post.

Client computer 205 includes a browser application 206. Browser application 206 accesses, processes, and displays information such as feed content for a user. When the browser application 206 requests a feed, feed server 215 merges feed item objects from class feed table 219 and the user feed table 220 to create a sortable user-specific list. That is, rather than loading the entire feed item table 218 and directly sorting the feed item objects, feed server 215 uses the user-specific list to first sort, filter, and search through feed items. In doing so, feed server 215 only retrieves the resulting feed items from feed item table 218 instead of performing expensive operations on the entire database of feed item objects.

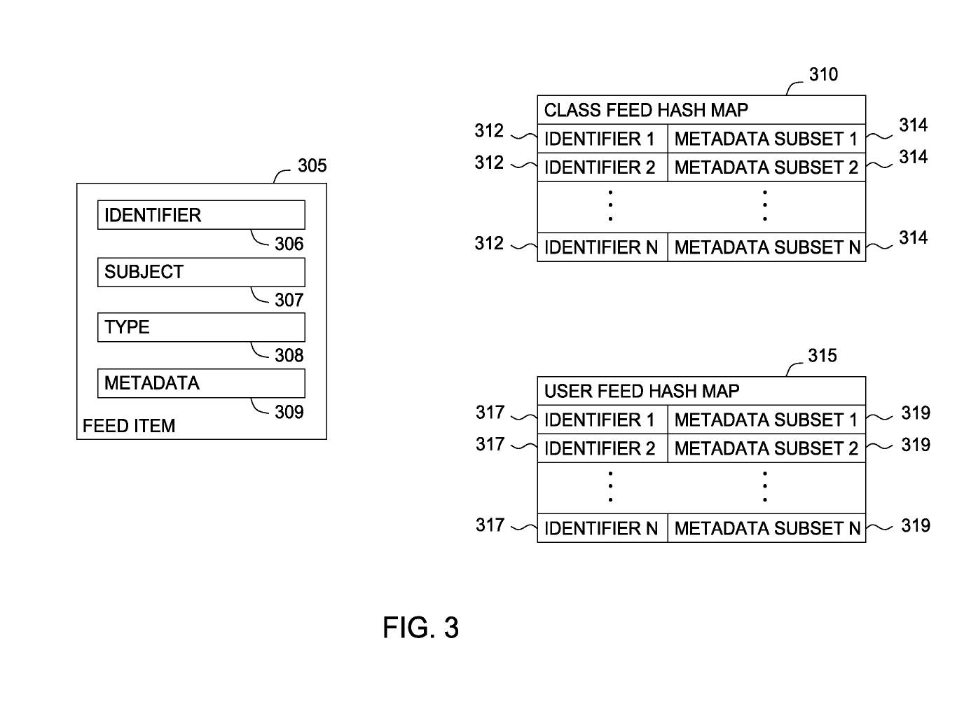

FIG. 3 illustrates an example feed item and feed objects, according to one embodiment. Assume that a feed item 305 represents a question item in the class web service interface. As shown, a feed item 305 includes an identifier 306, subject 307, type 308, and metadata 309. Identifier 306 is a unique value across the feed item table. Feed objects having items that correspond to the present item share the same identifier 306. Subject 307 may be a text string representing the subject of a post. Type 308 is a value that describes the type of post that the present feed item corresponds to, such as a question or a note. Metadata 309 values describe further information about feed item 305. Examples of such information are the date that feed item 305 was created, a log of edits made to feed item 305, the owner of feed item 305, the number of “likes” feed item 305 has received, etc.

In one embodiment, the class feed object and user feed object may be implemented as hash maps, shown in FIG. 3 as class feed hash map 310 and user feed hash map 315. Both hash maps have keys and values, where a key corresponds to the identifier of a feed item and a value is a subset of metadata for the particular hash map. Class feed hash map 310 includes a set of identifiers 312, as well has metadata subsets 314 as corresponding hash values. The identifiers 312 may be used as hash keys. In the ongoing example, the metadata subsets of class feed hash map 310 may include the date the feed item was created, how many “likes” the feed item has received, and whether an instructor provided input to the feed item. That is, the metadata subsets 319 include information that a feed server uses in performing sort, filter, and search operations.

Similarly, user feed hash map 315 includes identifiers 317 and metadata subsets 319. In the continuing class web service example, metadata subsets 319 may include how many updates to a feed item a user has seen since last viewing the feed item, whether the user “archived” the feed item (i.e., removed the item from the feed), and whether the user has not yet viewed the feed item. That is, the metadata subsets 319 of user feed hash map 315 correspond to user-specific information.

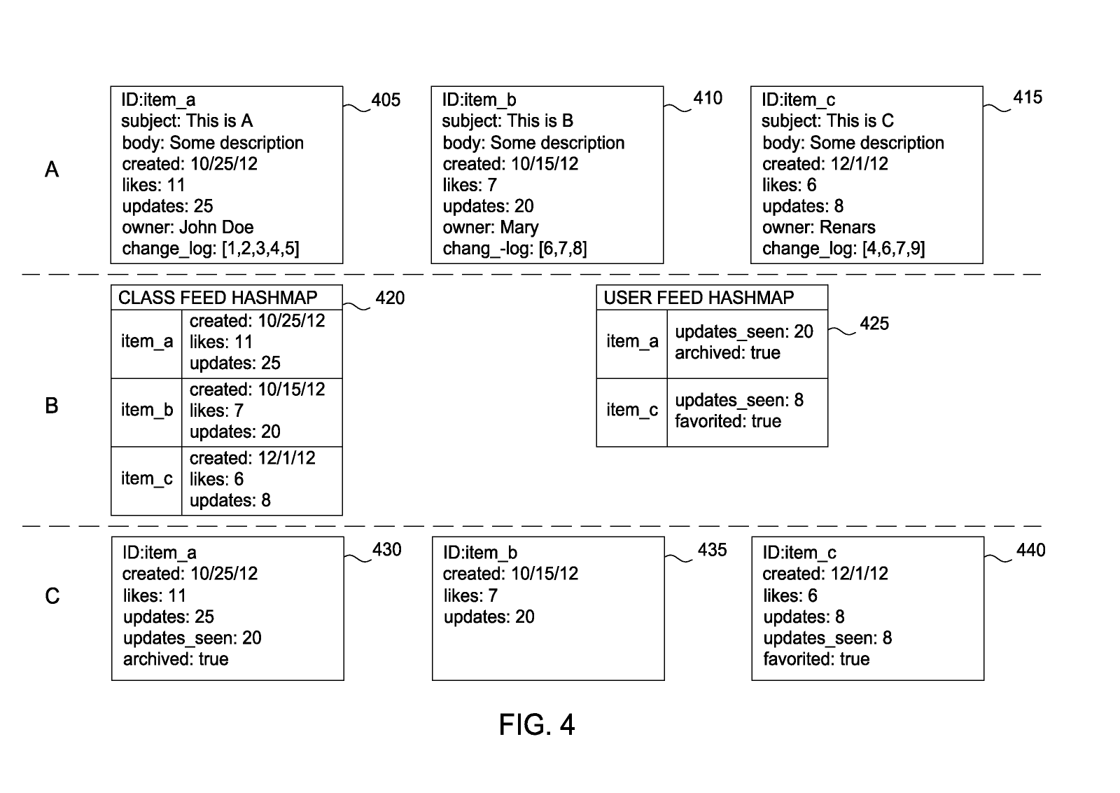

FIG. 4A illustrates an example feed generation scenario as a specific-use case, according to one embodiment. FIG. 4a shows three feed items 405, 410, and 415. Assume that feed items 405, 410, and 415 are the only items stored in the feed item table and are specific to one university class. As shown, feed items 405, 410, and 415 include identifiers “item_a,” “item_b,” and “item_c.” Feed items 405, 410, 415 also include fields for metadata, such as “created,” “likes,” “updates,” and “owner.”

FIG. 4B illustrates a class feed hash map 420 and a user feed hash map 425. The hash map keys correspond to the identifiers of the feed items and the hash map values correspond to subsets of metadata for the feed items shown in FIG. 4a. As shown, class feed hash map 420 includes three feed items, represented by identifiers as “item_a,” “item_b” and “item_c.” The associated metadata includes fields for “created,” “likes,” and “updates,” as well as field values. Further, user feed hash map 425 includes two feed items, represented by identifiers “item_a” and “item_c.” The associated metadata for user feed hash map 425 includes “updates seen” and “archived.” Neither class feed hash map 420 nor user feed hash map 425 includes the entire set of metadata. Instead, each hash map only includes a subset of metadata that a feed server uses to perform sort, filter, and search operations on the user need. For example, because the “owner” of a feed item may not be required to sort and filter feed items, “owner” may be omitted from the hash maps.

FIG. 4C illustrates a user-specific sorting list that contains items 430, 435, and 440. As shown, the list includes the same identifiers “item_a,” “item_b,” and “item_c” of class feed hash map 420 and user feed hash map 425 of FIG. 4b. Further, list items 430, 435, and 440 include consolidated metadata values from the class feed hash map 420 and the user feed hash map 425. The feed server sorts and filters feed items in the list before retrieving the full feed item metadata from the feed item table.

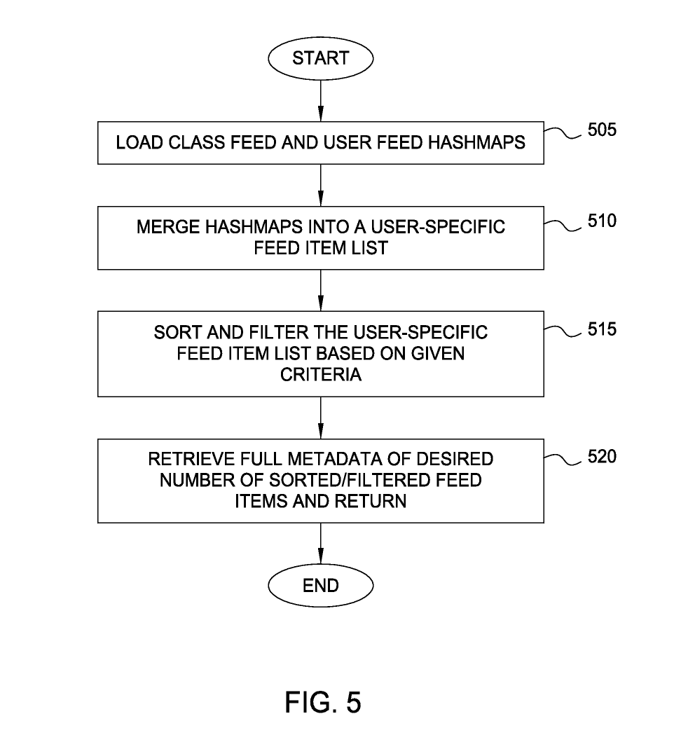

FIG. 5 illustrates a method 500 for generating a user-specific feed, according to one embodiment. More specifically, method 500 illustrates the feed generation from the perspective of a feed server. Assume that the feed server has already received criteria from the client web browser application of how many posts and what kinds of posts the feed should present. Additionally, assume that the user wants to see how many updates have occurred since the user last viewed a post and additionally wants to filter out posts that the user has marked as archived. The method begins at step 505, where the feed server loads the class feed hash map and user feed hash map from memory. As shown in FIG. 4b, class feed hash map 420 includes feed items with identifiers “item_a,” “item_b,” and “item_c,” and user feed hash map includes feed items with identifiers “item_a” and “item_c.” Further, the identifiers are associated with feed items in the feed item table (shown in FIG. 4a). Feed items 405, 410, and 415 include all the metadata for a particular item, but class feed hash map 420 and user feed hash map 425 contain only subsets of metadata for the associated feed items. For instance, class feed hash map 420 includes metadata that a feed server uses to perform a sort and filter operation. As shown, the metadata includes the date created, the number of “likes” the feed item has received, and the number of updates the feed item has received. Of course, more generally, the metadata can relate to a variety of feed items. Additionally, the user feed hash map 425 includes user-specific metadata. As shown, this includes a number of updates the user has seen, whether the user marked the list item as a “favorite,” and whether the user “archived” the list item.

At step 510, the feed server merges the class feed hash map and the user feed hash map to create a user-specific feed item list. FIG. 4C shows the list created from merging class feed hash map 420 with user feed hash map 425. As shown in FIG. 4C, the list includes the feed items with identifiers “item_a,” “item_b” and “item_c,” and the list also includes consolidated metadata from both class feed hash map 420 and user feed hash map 425. At step 515, the feed server sorts and filters the user-specific feed item list based on given criteria. Because the criteria relates to the number of the most recent updates that have not yet been “archived,” the server performs the sort and filter operations on the sortable list based on that criteria. At step 520, the feed server retrieves the full metadata of the desired number of sorted and filtered feed items and returns the items complete with metadata to the browser application. In this case, the feed server would return the full metadata of the feed items in FIG. 4a with identifiers “item_b” and “item_c.” Upon receiving the feed item metadata from the feed server, the browser application may display the feed items to the user interface.

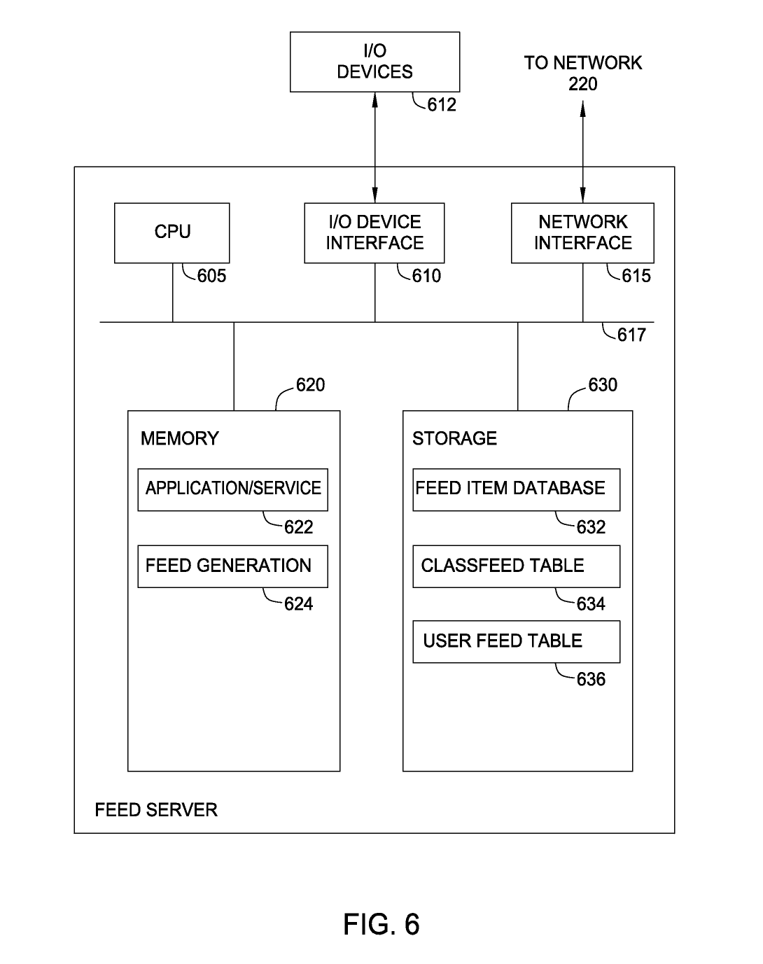

FIG. 6 illustrates an example feed server computing system 600 configured to generate a user-specific content feed, according to one embodiment. As shown, the computing system 600 includes, without limitation, a central processing unit (CPU) 605, a network interface 615, a memory 620, and storage 630, each connected to a bus 617. The computing system 600 may also include an I/O device interface 610 connecting I/O devices 612 (e.g., keyboard, display and mouse devices) to the computing system 600. Further, in context of this disclosure, the computing elements shown in computing system 600 may correspond to a physical computing system (e.g., a system in a data center) or may be a virtual computing instance executing within a computing cloud.

The CPU 605 retrieves and executes programming instructions stored in the memory 620 as well as stores and retrieves application data residing in the storage 630. The interconnect 617 is used to transmit programming instructions and application data between the CPU 605, I/O devices interface 610, storage 630, network interface 615, and memory 620. Note, CPU 605 is included to be representative of a single CPU, multiple CPUs, a single CPU having multiple processing cores, and the like. And the memory 620 is generally included to be representative of a random access memory. The storage 630 may be a disk drive storage device. Although shown as a single unit, the storage 630 may be a combination of fixed and/or removable storage devices, such as fixed disc drives, removable memory cards, or optical storage, network attached storage (NAS), or a storage area-network (SAN).

Illustratively, the memory 620 includes an application/service 622 and a feed generation component 624. The application/service 622 generally provides one or more software applications and/or computing resources accessed over a network 220 by users. Storage 630 includes a database 631 storing a feed item table 632, a class feed table 634, and a user feed table 636. In practice, the components of memory 620 and storage 630 may be hosted on separate machines. Feed item table 632 includes feed item data and metadata. Class feed table 634 includes the same feed items in feed item table 632 but only with a subset of the metadata for use in performing sort and filter operations. User feed table 636 likewise includes the same feed items in feed item table 632 but only with a subset of the metadata that is specific to a user. Feed generation component 624 loads the tables located in database 631 and performs sort, filter, and retrieval operations on feed item data. As described, feed generation component 624 merges a class feed object located in class feed table 634 with a user feed object located in user feed table 636 to create a sortable list. Upon performing sort and filter operations using given criteria, feed generation component 614 retrieves the full metadata for the resulting feed items from feed item table 632 and returns the information to the client web browser.

Advantageously, embodiments presented herein provide techniques efficiently generating user-specific feeds to a browser application. Rather than loading every feed item into memory before sorting and filtering the items, a feed server instead saves separate feed objects with only metadata needed to sort, filter, and search the object. Once the feed server performs the sort and filter operations, the feed server accesses the full feed item metadata to display to a user. Saving a class feed into a single object and merging the object with a user feed object to create a sortable list avoids having to work around database query limitations to produce optimal results. Accordingly, because the feed server does not load all feed items into memory before performing the sort and filter operations, less overall memory is required to generate the user-specified feed.

While the foregoing is directed to embodiments of the present invention, other and further embodiments of the invention may be devised without departing from the basic scope thereof, and the scope thereof is determined by the claims that follow.

What is claimed is:

1. A method for generating a content feed, comprising:
loading a first feed object referencing a first set of feed items, wherein the first feed object includes feed metadata for each feed item in the set of feed items;
loading one of a plurality of second feed objects, wherein the second feed object references one or more of the feed items in the first set, and wherein the second feed object includes user metadata for each feed item referenced by the second feed object for one of a plurality of users;
for each feed item referenced by the second feed object, merging the user metadata with the feed metadata for the corresponding feed item in the first feed object to create a merged feed object;
identifying a set of feed items referenced in the merged feed object; and
retrieving the feed items referenced in the merged feed object.

2. The method of claim 1, further comprising, returning the feed items referenced in the merged feed object to a web browser application.

3. The method of claim 1, wherein identifying a subset of feed items referenced in the merged feed object comprises:
sorting the feed item references based on a sort criteria;
filtering the feed item references based on a filter criteria;
searching the feed item references based on a search criteria; and
returning the filtered feed item references.

4. The method of claim 1, wherein the first feed object, the second feed object, the merged feed object, and the master feed object are hash maps.

5. The method of claim 1, wherein the user metadata includes at least one of a number of updates seen by a user, an archive flag, and a last read value.

6. The method of claim 1, wherein the feed metadata includes at least one of a date created value, a number of updates, and a number of endorsements.

7. The method of claim 1, wherein the merged feed object is a sortable list.

8. A computer-readable storage medium storing instructions, which, when executed on a processor, performs an operation for generating a content feed based on a sort and filter criteria, the operation comprising:
loading a first feed object referencing a first set of feed items, wherein the first feed object includes feed metadata for each feed item in the set of feed items;
loading one of a plurality of second feed objects, wherein the second feed object references one or more of the feed items in the first set and wherein the second feed object includes user metadata for each feed item referenced by the second feed object for one of a plurality of users;
for each feed item referenced by the second feed object, merging the user metadata with the feed metadata for the corresponding feed item in the first feed object to create a merged feed object;
identifying a set of feed items referenced in the merged feed object; and
retrieving the feed items referenced in the merged feed object.

9. The computer-readable storage medium of claim 8, the operation further comprising, returning the feed items referenced in the merged feed object to a web browser application.

10. The computer-readable storage medium of claim 8, wherein identifying a subset of feed items referenced in the merged feed object comprises:
sorting the feed item references based on a sort criteria;
filtering the feed item references based on a filter criteria;
searching the feed item references based on a search criteria; and
returning the filtered feed item references.

11. The computer-readable storage medium of claim 8, wherein the first feed object, the second feed object, the merged feed object, and the master feed object are hash maps.

12. The computer-readable storage medium of claim 8, wherein the user metadata includes at least one of a number of updates seen by a user, an archive flag, and a last read value.

13. The computer-readable storage medium of claim 8, wherein the feed metadata includes at least one of a date created value, a number of updates, and a number of endorsements.

14. The computer-readable storage medium of claim 8, wherein the merged feed object is a sortable list.

15. A system, comprising:
a processor and
a memory hosting an application, which, when executed on the processor, performs an operation for delivering push events each having an identifier and a timestamp, the operation comprising:
loading a first feed object referencing a first set of feed items, wherein the first feed object includes feed metadata for each feed item in the set of feed items,
loading one of a plurality of second feed objects, wherein the second feed object references one or more of the feed items in the first set and wherein the second feed object includes user metadata for each feed item referenced by the second feed object for one of a plurality of users,
for each feed item referenced by the second feed object, merging the user metadata with the feed metadata for the corresponding feed item in the first feed object to create a merged feed object,
identifying a set of feed items referenced in the merged feed object, and
retrieving the feed items referenced in the merged feed object.

16. The system of claim 15, the operation further comprising, returning the feed items referenced in the merged feed object to a web browser application.

17. The system of claim 15, wherein identifying a subset of feed items referenced in the merged feed object comprises:
sorting the feed item references based on a sort criteria;
filtering the feed item references based on a filter criteria;
searching the feed item references based on a search criteria; and
returning the filtered feed item references.

18. The system of claim 15, wherein the first feed object, the second feed object, the merged feed object, and the master feed object are hash maps.

19. The system of claim 15, wherein the user metadata includes at least one of a number of updates seen by a user, an archive flag, and a last read value.

20. The system of claim 15, wherein the feed metadata includes at least one of a date created value, a number of updates, and a number of endorsements.

21. The system of claim 15, wherein the merged feed object is a sortable list.
